(19) United States
(12) Patent Application Publication
(10) Pub. No.: US 2009/0091148 A1
(43) Pub. Date: Apr. 9, 2009

(54) Chip card receiving device comprising a carriage for holding a chip card

(75) Inventors: Heinz-Josef Hautvast, Brigachtal (DE); Thomas Riester, Villingen-Schwenningen (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens

(21) Appl. No.: 12/315,439

(22) Filed: Dec. 3, 2008

Related U.S. Application Data
(63) Continuation of application No. 10/896,279, filed on Jul. 22, 2004.
Application No. 10/896,279 is a continuation of application No. PCT/DE03/00442, filed on Feb. 13, 2003.

(30) Foreign Application Priority Data
Feb. 26, 2002 (DE) 10208259.6

(51) Int. Cl. B25J 15/06

(52) U.S. Cl. 294/64.1

(57) ABSTRACT

A chip-card-receiving device has a carriage for holding a chip card, means for fixing and releasing a chip card, and a clamping element. The carriage is displaceably mounted between an insertion/removal position and a reading/writing position on a carrier. The clamping element is spring-mounted on the carriage such that the clamping element rests resiliently on an inserted chip card. The clamping element has ramps formed on the carrier such that the clamping element is lifted from a plane of the chip card in an insertion/removal position of the carriage.

### CROSS REFERENCE TO RELATED APPLICATIONS

The present application is a continuation of International Application PCT/DE03/00442, filed Feb. 13, 2003, which designated the United States, and further claims priority to German Patent Application 10208259.6, filed Feb. 26, 2002, the both of which are herein incorporated by reference.

### BACKGROUND OF THE INVENTION

The invention relates to a chip card receiving device comprising a carriage for holding a chip card which is moveably mounted on a carrier between an insertion/removal position and a read/write position, and also comprising means for tightly clamping and releasing a chip card.

The use of chip cards, for example to record the personal working and resting times of the drivers of commercial vehicles, requires reliable safeguards to prevent disruptions, caused for purposes of deception, to the data transfer between the data recording device, in this case a tachograph, and a chip card, owing to the documentary value of these recordings. Also, when chip cards are used in commercial vehicles an increased risk exists of contact interruptions between a read/write contact assembly and the chip cards because of the general environment in which they have to operate. Furthermore, when chip cards are used in tachographs they have to be inserted and removed relatively frequently owing to changes of driver and vehicle as well as road traffic checks and the chip cards are not always handled with the requisite care. As a result, and also because the chip cards are carried and kept outside the vehicle, the chip cards can be damaged or deformed. Such deformations of chip cards as well as the unavoidable effects of operational vibrations and jolts must not, however, lead to the read/write contacts being damaged when the chip card is inserted in the receiving device or the function of the chip card being disrupted when it is in the read/write position.

The transport of the chip cards within the receiving device between the insertion/removal position and the read/write position represents a further problem. If a chip card is inserted exclusively by hand there is a risk that it will not be exactly positioned in the read/write position. Moreover, as an inserted chip card is accessible from the outside, manipulation is possible, even if the receiving device concerned is fitted at the front with locking bars or a cover plate. In order to prevent influence being exerted from the outside and to ensure precise positioning and contacting of the inserted chip card, automatic transport of the chip cards between the insertion/removal position and the read/write position is therefore to be preferred even though this may involve greater expense. The operational environment in the commercial vehicle and the dirt, in particular from oils and greases, encountered owing to the relatively frequent handling of the chip cards, as well as the tolerances and thickness differences of the chip cards from large production series mean, however, that an apparently appropriate transport arrangement with a suitably driven friction shaft or with friction rollers does not offer adequate transport reliability. This is because if the chip card jammed, especially during transport to the removal position, the functioning of the tachograph concerned would be considerably disrupted.

In a transport arrangement which became known with the DE 198 09 619 A1 the chip cards are tightly clamped onto a moveably mounted carriage by being gripped from the side. This purpose is served by a moveable slider which is spring-mounted on the carriage laterally to the direction of movement of the carriage. The slider is controlled by a gate of a tilt spring mechanism which is triggered when a chip card is inserted in the receiving device concerned.

In principle, and in particular as far as gripping a chip card is concerned, this transport arrangement permits a high compressive load per unit area and thus prevents relative movement between the chip card and the carriage during transport. It does not, however, offer a holddown function for curved or bent chip cards. Moreover, the gripping function can be restricted or no longer apply at all in the case of deformed chip cards. A further disadvantage exists in that the gripping function can be simply manipulated by reducing the width of a chip card.

### SUMMARY OF THE INVENTION

The task underlying the invention was therefore to create a chip card receiving device suitable for series production and for use in commercial vehicles which ensures absolutely secure transport of the chip cards and reliable contacting of the chip cards in the read/write position even if the chip cards are deformed or damaged and which can be realized with as much space-saving effect as possible.

The solution of the task provides that two clamping elements are spring-mounted on the carriage in such a way that they close towards each other like tongs and that configured guides are assigned to the clamping elements on the carrier in such a way that the clamping elements are raised up from the level of the chip card in the insertion/removal position of the carriage, and during insertion of a chip card and movement of the carriage into the read/write position they in each case rest resiliently on the surfaces of the chip card determined by length and width.

A preferred exemplary embodiment is characterized in that toothing is configured on the carriage and the carriage is connected by means of gearing with a motor which is reversible in its direction of rotation and that each clamping element on the side facing the chip card level is covered with a frictional material.

Further advantageous embodiments of the invention derive from the subclaims, not cited above, and from the description of the attached drawings.

The invention in particular offers the advantage that a high compressive load per unit area can be exerted so that even if the coefficient of friction is reduced by dirt contamination, adequately high holding forces are effective. Furthermore, as a result of the tongs function, i.e. the gripping of the clamping elements on both sides over a large area, and through the use of suitable frictional coverings a high adhesion effect is achieved between a chip card and the clamping elements, which ensures that a chip card is moved without slipping during transport and a chip card is held in the read/write position without being exposed to vibration and jolts, and because the carriage can be mounted on the carrier to a relatively tight tolerance, vibration-related abrasion of the chip card contacts is avoided. It can also be highlighted that a clamping element gripping around the contact field of an inserted chip card is effective as a holddown device in the direct contact area and in this way reliable contacting including of uneven chip cards is made possible. Moreover, despite its robust design the solution found offers a high level of security against manipulation as the clamping elements rest with considerable force on the entire width of a chip card and are also guided in grooves along the side, which means that they cannot be lifted up in the read/write position. As a result of the found solution it is therefore not essential to attach additional locking elements to the chip card receiving device, even if unlike in the preferred exemplary embodiment which provides for positively engaged transport of the carriage holding the chip cards independently of the care taken by the user, the chip cards are exclusively inserted by hand in the read/write position and are moved in a friction grip into the removal position by means of a suitably driven pushrod.

For the sake of completeness it should also be mentioned that although the application of the chip card receiving device in accordance with the solution is optimized for use in commercial vehicles, it is also eminently suitable for general use because it is relatively inexpensive to produce and install and including the drive system is low in height. In this context the preferred exemplary embodiment represents a useful, largely autonomous assembly which with the incorporation of suitable spacer bolts can be assigned to a printed circuit board with minimal space requirement. In addition, the design of the chip card receiving device with a torsionally rigid carrier, which for example can be configured as an outsert plate, and the direct assignment of the individual components and assemblies to the carrier, represents a minimal tolerance addition, so that the units can be produced with tolerances suitable for large series. Furthermore, it should be pointed out that a simplified version can be made by providing just one clamping element which works directly together with a suitably configured carriage on the side of the carriage facing the stationary contact assembly.

### BRIEF DESCRIPTION OF THE SEVERAL VIEWS OF THE DRAWINGS

The preferred exemplary embodiment of a chip card receiving device is explained below in more detail with reference to the attached drawings, in which:

FIG. 1 shows a top view of the chip card receiving device at the level of the flange mounting,

FIG. 2 shows a bottom view of the chip card receiving device as in FIG. 1,

FIG. 3 shows a section along line of intersection A in FIG. 1, enlarged,

FIG. 4 shows a top view as in FIG. 1 with a chip card in the read/write position, and

FIG. 5 shows a side view in arrow direction C in FIG. 4.

### DETAILED DESCRIPTION OF THE INVENTION

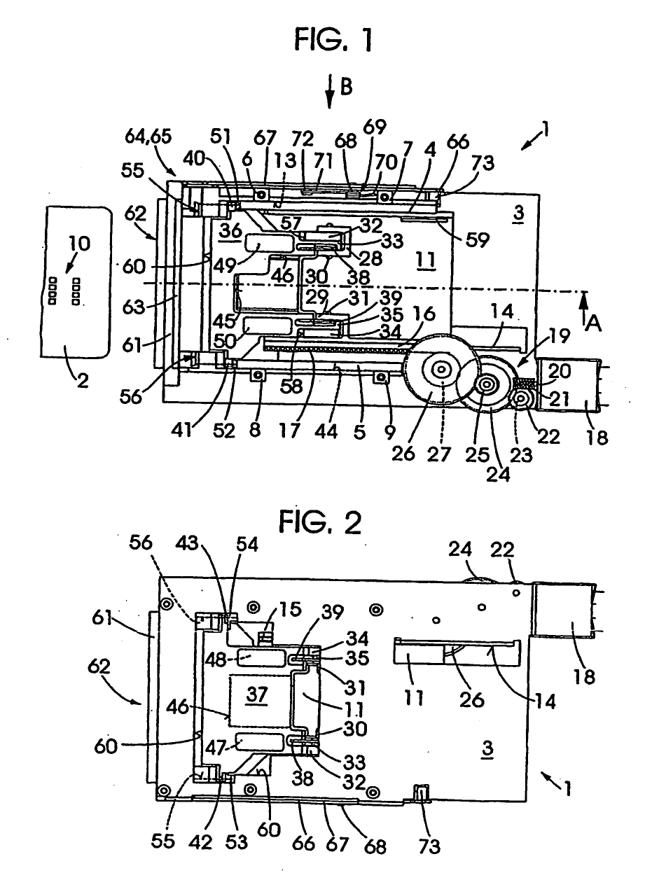

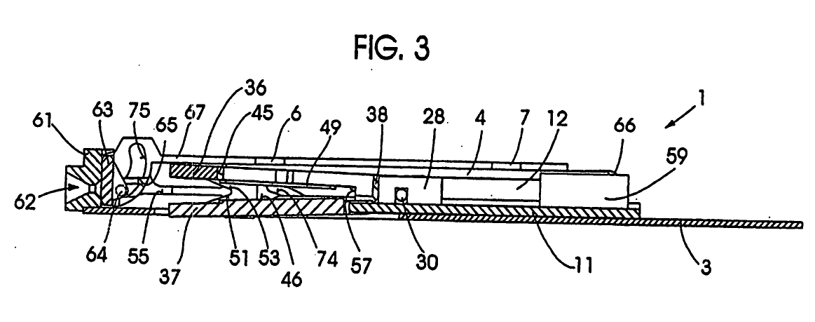

As can be seen from the drawings, the chip card receiving device 1, to which a chip card 2 has been symbolically assigned, exhibits a torsionally rigid carrier 3 on which rails 4 and 5 are fastened, preferably formed on by outsert injection molding. The supports 6, 7, 8 and 9 assigned to the rails 4, 5 and featuring tapped holes not further designated serve the purpose of fastening the chip card receiving device 1, e.g. onto a printed circuit board on which expediently a contact assembly assigned to the board contacts 10 of the chip cards 2 is arranged. With 11 a carriage is designated which by means of a cheek 12 engages with an undercut 13 provided in the rail 4 and which is mounted moveably in longitudinal direction on a strip 14 configured on the carrier 3, to which strip a slot 15 (FIG. 2) configured in the carriage 11 is assigned. A further cheek 16 of the carriage 11 features toothing 17 via which the carriage 11 is functionally connected by means of gearing with a positioning motor 18 which is reversible in its direction of rotation. The gear system 19 comprises a worm 21 fastened to the shaft 20 of the positioning motor 18, a first pair of gear wheels with a helical gear 22 engaging with the worm 21 and a spur gear 23, a pair of gear wheels 24/25 with an interposed friction coupling as well as a pair of gear wheels 26/27, one gear wheel of which engages with the toothing 17 of the carriage 11. On the carriage 11 bearing blocks 28 and 29 are configured which serve the purpose of supporting axles 30 and 31 on which in each case a leg 32 and 33 as well as 34 and 35 of two clamping elements 36 and 37 are mounted. In addition, the axles 30, 31 serve the purpose of supporting leg springs 38 and 39, of which in each case one pretensioned leg acts on one of the clamping elements 36, 37 in such a way that the clamping elements 36, 37 close towards each other like tongs. In addition, fingers 40, 41 and 42, 43 are arranged facing each other on the clamping elements 36, 37 and are configured in such a way that the fingers 40, 42 engage with the undercut 13 and the fingers 41, 43 with an undercut 44 configured in rail 5. As FIG. 1 shows, the clamping element 36 features a recess 45 which permits the penetration of the contact springs of the read/write contact assembly onto the board contacts 10 of a chip card 2 which is in the read/write position, so that the clamping element 36 is configured in a U or stirrup shape. By contrast, the clamping element 37 exhibits a platform 46 facing an inserted chip card 2. On both sides of the platform 46 frictional coverings 47 and 48 are affixed to the clamping element 37. Located opposite to them are frictional coverings 49 and 50 on clamping element 36. The frictional coverings 47, 48, 49, 50, which in conjunction with the leg springs 38, 39 serve the purpose of holding an inserted chip card 2 tightly both during transport and in the read/write position, can be advantageously supplemented by affixing frictional coverings to the clamping elements additionally crosswise to the insertion direction of the chip cards and parallel to the axes of clamping elements 36, 37. It is conceivable that only the last-mentioned frictional coverings are provided because they offer the advantage that access to the contact area from the outside with interrupting or conducting foils or wires is excluded.

As can also be seen from the drawings, ramps 51 and 52 and 53 and 54 formed onto the rails 4, 5 are assigned to the clamping elements 36, 37 or to the fingers 40, 41, 42, 43 configured on the clamping elements 36, 37. Guide slots configured between the ramps 51, 52 and 53, 54 and assigned to the chip card 2 are designated with 55 and 56. Stop surfaces 57 and 58 are configured on the legs 32 and 34 of the clamping element 37 via which, when the chip card 2 is inserted, the carriage 11 is moved slightly by hand until it is automatically transported. This is controlled by a light barrier whose lug is assigned to the carriage 11 and designated with 59. A recess 60 enables the clamping element 37 to penetrate through the level of the carrier 3. In a front beam 61 fastened onto the carrier 3 or formed onto the carrier 3 an orientation slot 62 is configured which facilitates the alignment of a chip card 2 being inserted. In addition, a flap 63, which acts as a cover for the orientation slot 62, is swivel-mounted on the front beam 61. The flap 63 is coupled by means of a pin-slot connection 64, 65 with a double-arm control lever 66 which is rotationally mounted on an axle 68 fastened to a side wall 67 of the carrier 3. On the control lever 66, to which a leg spring 69 likewise arranged on the axle 68 is assigned, whose one leg 70 is supported on the carrier 3 and whose other leg 71 abuts on a pin 72 fastened in the control lever 66, a guide pin 73 is attached to which a gate 74 configured in the carriage 11 is assigned. A slot-shaped recess 75 is provided for friction-free movement of the pin 64 in the pin-slot connection 64/65 in the side wall 67.

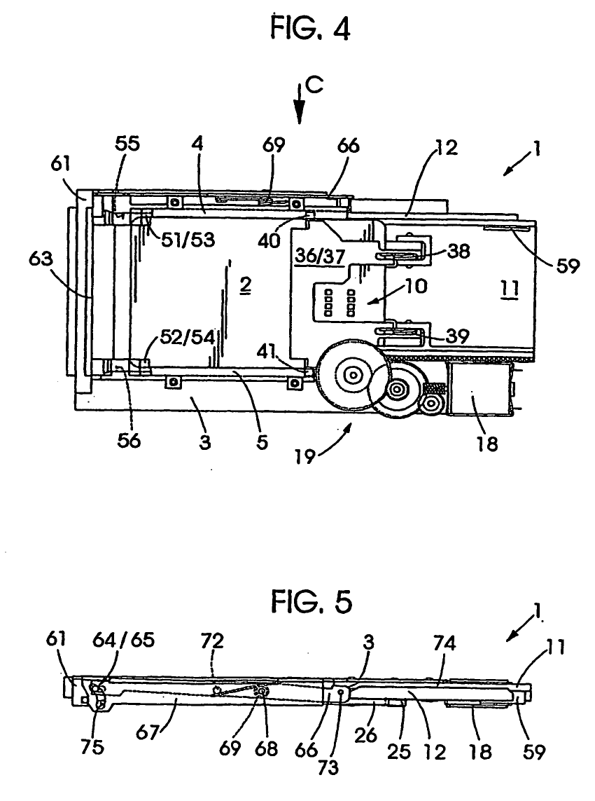

In the position of the carriage 11 shown in FIG. 1 the flap 63 abutting on the front beam 61 and covering the orientation slot 62 can be swiveled against the effect of the leg spring 69 when a chip card 2 is inserted. In the position of the carriage 11 shown in FIG. 4 in which an inserted chip card 2 is in the read/write position the flap 63 is arrested by the guide pin 73 engaging with gate 74. On insertion of a chip card 2 through the orientation slot 62 the chip card 2 guided in the guide slots 55, 56 comes into contact with the stop surfaces 57, 58. Further movement of the chip card 2, which is possible owing to the friction coupling assigned to the pair of gear wheels 24/25, causes the clamping elements 36, 37 to slide off the ramps 51, 52 and 53, 54 and the clamping elements 36, 37 to become active on chip card 2, i.e. chip card 2 is tightly clamped on the carriage 11 and then by means of the geared connection of the carriage 11 the chip card 2 is transported into the read/write position shown in FIG. 4. The clamping elements 36, 37 and the chip card 2 gripped by them are guided by the finger pairs 40, 42 and 41, 43 loosely into the undercuts 13, 44 and supported by the carrier 3. At this point it should be mentioned that the chip card receiving device 1 can be equipped with just one clamping element which works in conjunction with the base of a suitably configured carriage. It should also be mentioned that the gear system 19 can be configured in such a way that self-locking is avoided and therefore the friction coupling can be dispensed with. For ejecting the chip card 2, which, having been initiated by pressing a button on the unit concerned, is performed automatically by the positioning motor 18 and the gear system 19, the clamping elements 36, 37 are “opened” by sliding onto the ramps 51, 52, 53, 54 and the chip card 2 is released.

What is claimed is:

1. A chip-card-receiving device comprising:
a carriage for holding a chip card, the carriage mounted displaceably between an insertion/removal position and a reading/writing position on a carrier, and comprising means for fixing and releasing a chip card; and
two clamping elements spring-mounted on the carriage so as to act against each other, the clamping elements including assigned guides formed on the carrier such that the clamping elements are lifted from a plane of the chip card in the insertion/removal position of the carriage and rest resiliently on areas of the chip card determined by length and width during insertion of a chip card and displacement of the carriage into the reading/wring position.

2. The chip-card-receiving device of claim 1, further comprising:
a serration formed on the carriage, and
a servo motor connected to the carriage via a gear mechanism, the servo motor arranged so as to be reversed in its direction of rotation.

3. The chip-card-receiving device of claim 2, further comprising a slip clutch connected via a gear mechanism between the servo motor and the carriage.

4. The chip-card-receiving device of claim 1, wherein each clamping element comprises a friction coating on a side of the clamping element facing the chip card plane.

5. The chip-card-receiving device of claim 1, wherein the chip cards further comprise guiding slots formed on the carrier and a stop formed on the carriage.

6. The chip-card-receiving device of claim 1, further comprising a clamping element formed by a clearance in a u-shaped form such that in the reading/writing position of the carriage the reading/writing contacts pass between legs of the clamping element.

7. The chip-card-receiving device of claim 1, wherein at least in the reading/writing position of a chip card, the clamping elements are held between rails and the carrier.

8. The chip-card-receiving device of claim 1, further comprising a flap assigned to an orientation slot of the chip-card-receiving device such that in the reading/writing position of the carriage the orientation slot is locked, and in the insertion/removal position of the carriage the flap is pivoted by a chip card inserted from outside.

9. The chip-card-receiving device of claim 8, wherein the flap is operatively connected by means of a pin-slot connection with a control lever spring-mounted to the carrier, and the control lever is engageable by means of a guiding pin in a slotted link formed in the carriage.

10. A chip-card-receiving device comprising:
a carriage for holding a chip card, the carriage being displaceably mounted between an insertion/removal position and a reading/writing position on a carrier;
means for fixing and releasing a chip card; and
a clamping element spring-mounted on the carriage such that the clamping element rests resiliently on an inserted chip card, the clamping element comprising ramps formed on the carrier such that the clamping element is lifted from a plane of the chip card in an insertion/removal position of the carriage.
